(19) United States
(12) Patent Application Publication
(10) Pub. No.: US 2009/0047637 A1
(43) Pub. Date: Feb. 19, 2009

(54) Teaching aid for accounting

(75) Inventor: Peter Lawrence Frampton, Washington, DC (US)

Correspondence Address: THE NATH LAW GROUP, 112 South West Street, Alexandria, VA, 22314, US

(73) Assignee: COMES ALIVE INTERNATIONAL, INC., Tortola (VG)

(21) Appl. No.: 12/222,988

(22) Filed: Aug. 21, 2008

Related U.S. Application Data
(63) Continuation-in-part of application No. 10/563,867, filed on Jan. 9, 2006.

(30) Foreign Application Priority Data
Jul. 8, 2003 (ZA) 2003/5346

(51) Int. Cl. G09B 19/18

(52) U.S. Cl. 434/109; 434/107

(57) ABSTRACT

Disclosed is a learning system and method that allows students with basic literacy to learn essential principles of accounting. No prior learning in accounting is presumed or required. Using a simple business simulation, students develop an accounting system for themselves. The learning system and method employs many of the key human learning senses of visual, auditory, kinesthetic, gustatory and olfactory. By creating a three dimensional accounting system and continually telling the story of the business as it evolves, students are using all of the necessary senses for effective and lasting learning.

This application is a continuation in part application of application Ser. No. 10/563,867, which was filed on Jan. 9, 2006.

### FIELD OF THE INVENTION

This subject matter relates generally to the field of education, and more particularly to a method of helping non-accountants become literate in accounting and some basic elements of financial management.

### BACKGROUND

In business today, managers and other primary influencers of business results are expected to be accounting literate so they can understand both how their actions impact on those results, and also the results themselves. It has been very difficult for many people to gain the required level of accounting literacy using traditional offerings which all tend to use a similar conceptual modeling process combined with rote learning. This type of learning style does not work well with all people.

Previously technologies in this area start from the same premise: that the student must simply accept the principles embodied in the technology and then use the technology to define an accounting outcome. The user is able to use the technology but does not understand why it works, or how to use the learning in a different situation (called “generalization”). Whilst attempting to serve the student with simplicity, the student has been denied access to the very understanding that provides them with accounting literacy.

The current methods of teaching the double entry system of bookkeeping involve long and detailed formal study. Such methods may be appropriate for those who desire a career in accounting. However, with the increasing complexities in the day to day operations of most businesses, there exists the need for some teaching aid or educational device that is useful as an aid in teaching the rudimentary principles of accounting for the non-professional.

U.S. Pat. No. 3,889,395, U.S. Pat. No. 4,008,527 and U.S. Pat. No. 4,142,305 (all to Zegel) disclose a teaching device (demonstrator) or game for demonstrating how book-keeping works at a transactional level. The device is relatively complex as can be seen by the volume and complexity of the explanatory instructions. It claims to provide a novel teaching aid for simply and effectively demonstrating the rudimentary principles of double-entry accounting. However, it does not provide the student with an understanding of how those principles came about and how they work at a practical level. Consequently, the student is left with a device that he is required to learn by rote but no understanding of the principles involved in how the device works. The device represents ledger pages which are largely obsolete these days with the proliferation of computers and accounting software. In fact, much of the technology involved has been similarly superseded. A student is provided with a traditional version of the accounting equation (assets=claims), which the student must simply accept as true.

U.S. Pat. No. 4,336,019 to Schroeder discloses an educational accounting game. Colored game pieces are used “so that a number of numerical pieces match the color of a specific label piece.” This color-coding is only used to the extent of grouping the various financial statement categories together for convenience. Pre-printed labels are used extensively. The equation: “assets=liability+owners equity” is placed on the game-board in a pre-determined space. There is no opportunity for the students/game players to discover this fundamental accounting equation on their own. Rather, they must just accept that which is given to them and this is not conducive to learning the underlying principles. Further, pre-printed labels are provided with examples of balance sheets that could be put together. Again, the student is ‘fed’ the very information that they need to discover for themselves if they are to become accounting literate.

U.S. Patent Application Publication No. 2002/0164561 to Joffe discloses a method of teaching financial management of an enterprise using pre-printed financial statements and a set of monetary markers that can be used to represent the impact of transactions on the financial statements. It is rules-based, meaning that the accounting rules that underpin accounting literacy are all hard-coded into the pre-printed materials. This means that the student learns how to use the provided rules according to the provided examples, but will be unable to generalize the use of those rules to other situations not contemplated by the method. Joffe uses monetary markers (0034) “that may be likened to common paper currency.” Joffe provides various instructional boxes or messages to provide convenient reminders or assistance to the student.

### SUMMARY

Linking a symbol of ‘cash’ to the learning of accrual accounting creates a great deal of confusion for students. Many business transactions are not initially cash based, but are funds based. For example, a business buys some inventory (shoes) on credit. The business has received a new source of funds (effectively a loan from the shoe supplier) and has used those funds to acquire shoes to sell. The business can sell those shoes and re-use the cash received from the customer even before it has to pay the supplier's invoice. This is the type of transaction that can easily confuse students. Using markers that symbolize cash would only serve to exacerbate this confusion. Indeed, every effort must be made to remove or minimize distractions to the learning process.

Generally, the present system and method provides a novel teaching aid for effectively demonstrating the rudimentary principles of double-entry accounting. The inventive method and system uses all major learning styles to ensure that any motivated person with language literacy can become literate in accounting. Students learn the essential principles in accounting without having to use the terms: debit, credit or similar. Further, no accounting jargon words are used while the students are learning the essential principles, other than the ones the students may introduce themselves. By learning accounting as a language rather than a set of numerical rules, much of the fear that students may have prior to commencing the workshop dissipates and allows them to access their learning state.

A method of teaching accounting includes the step of providing a starting sheet having a use column and a source column that are both influenced by a plurality of actions and by a plurality of reactions. As will be noted later, the use column is subdivided into at least one subsection, one of which is marked “assets,” and the source column is also subdivided into at least one subsection, one of which is marked “liabilities.” The method also includes the step of representing a first action by a first non-verbal symbol and representing a first reaction by a second non-verbal symbol and includes the additional step of representing the use column by the first non-verbal symbol and representing the source column by the second non-verbal symbol. The first and/or second non-verbal symbol can be one of color, sound, texture, and fragrance.

Variations of the method include the step of using at least one ancillary container to represent a value (alternatively referred to herein as “amount”) within the use column or within the source column and using a second ancillary container to represent a value in the opposite column (source vs. use). The magnitude of the first action is equal and opposite the amount of the first reaction

Either ancillary container or both containers can be made of at least one of the first or second non-verbal symbols, i.e., color, sound, texture, and fragrance. The method as recited in claim 1 wherein a magnitude of said first action is equal and opposite to said first reaction.

Further variations of the method include adding a profit story sheet to the starting sheet. The profit story sheet includes a used-up funds section and an earned funds section and is positioned such that the used-up funds section is in vertical alignment with the use column and the earned funds section is in vertical alignment with the source column. Effectively, the used-up funds column is a subsection within the use column and the earned funds column is a subsection within the source column.

A system of teaching accounting includes a starting sheet that has a use column and a source column. The system also includes a first non-verbal symbol that represents a first transaction and a second non-verbal symbol that represents a second transaction. The first transaction is equal and opposite the second transaction. Further, the system includes a profit story sheet comprising a used-up funds section in vertical alignment with the use column and an earned funds section in vertical alignment with the source column.

Variations of the system include a first container and a second container, both of which can be comprised of one of the non-verbal symbols. The first and second containers represent first and second financial accounts, respectively. These financial accounts can represent accounts within the assets section, the source section, the used-up funds section, the earned funds section or the general profit story sheet. The non-verbal symbols for either transaction and/or container are color, sound, texture, or fragrance or some combination thereof.

### DESCRIPTION OF THE FIGURES

FIG. 1 shows a starting sheet for the inventive teaching method and system;

FIG. 2a shows a transaction diary;

FIG. 2b shows details of a horizontal slip of the transaction diary of FIG. 2a;

FIG. 3 shows transaction buckets;

FIG. 4a shows an expanded starting sheet;

FIG. 4b shows a perforated expanded starting sheet;

FIG. 5 shows an interpretation of the first steps of the inventive method;

FIG. 6 shows initial steps for performing the inventive method;

FIG. 7 shows more steps for performing the inventive method; and

FIG. 8 shows a transaction diary page having a particular sequence of introducing each transaction to students.

### DETAILED DESCRIPTION OF THE EMBODIMENTS

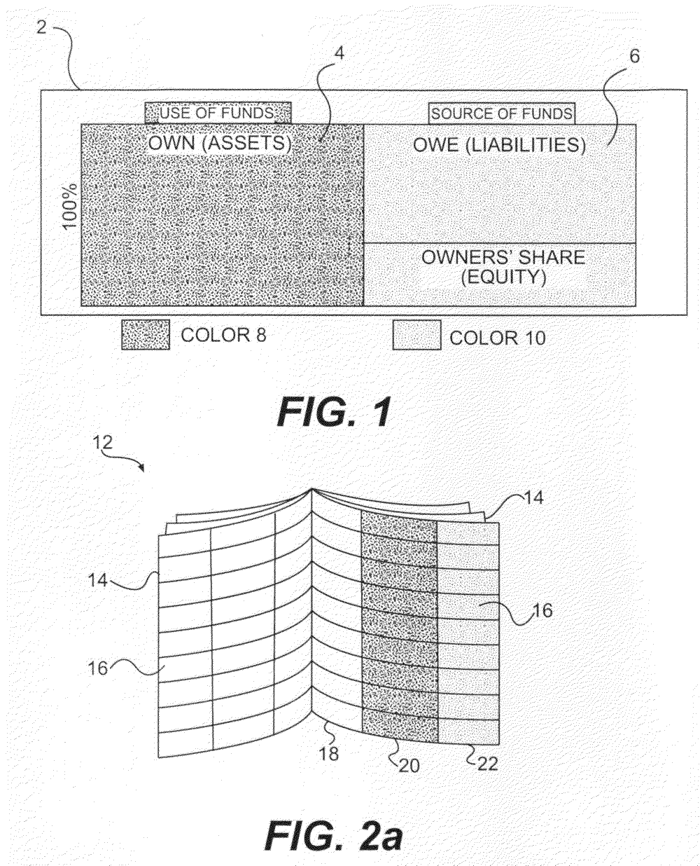

With reference to FIG. 1, the present system includes a starting sheet 2 having a use of funds column 4 (alternatively referred to as “use column”) and a source of funds column 6 (alternatively referred to as “source column”). Each column 4 and 6 is represented by a non-verbal symbol. In this embodiment, the use column 4 is represented by a first color 8 and the source column 6 is represented by a second color 10. The use of color allows a student to discover the principles of accounting in a natural and logical way using a unique story telling metaphor of a funding story. Because the student discovers the principles of accounting literacy for themselves, they are much more likely to both remember it and also to be able to build upon and develop further knowledge. The location of the colors and the two initial funding sources (liabilities—debt and equity) become a spatial learning anchor that the students can draw upon later when a more complex business funding story is developed.

The actual colors used in the system are arbitrary. The two-color scheme for funding becomes a learning technology anchor for the students so they can always differentiate the two sides of the funding story. The students will later use these same two colors (representing the source and use of funds) to differentiate two sides of a balance sheet and also to signify debits and credits. Color 8 represents “debit” and color 10 represents “credit.” Because the colors are far less threatening than the words “debit” and “credit,” the students discover their use and then use them easily. Each color, 8 and 10, can be replaced by two different types of patterns, two different types of paper stippling, etc. to represent the two sides of the funding story. People are able to intuitively learn debits and credits by using color in this way. A person having ordinary skill in the art will understand that indicia other than color can be used to identify use and source funds such as sound, texture, and fragrance or some combination thereof including combinations with color.

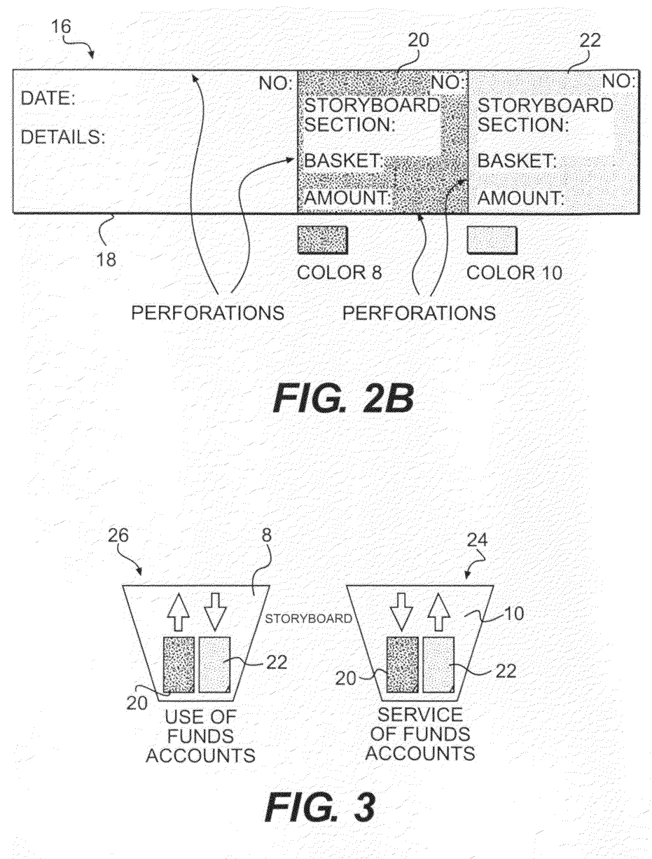

As shown in FIG. 2a, the system also includes a transaction diary 12 in which each page 14 is divided vertically into a number of identically marked horizontal slips 16. The original page has three vertical columns: a white column 18 for documenting the details of each transaction, a first column 20 having the first color 8 and second column 22 having the second color 10. The first column 20 and the second column 22, apart from their differentiating colors, are identical in format and layout. The opposing page contains no color, but can be used as a linear record of each transaction for backtracking if required. The transaction diary 12 represents a common accounting journal, but once again uses simple (non-jargonized) language, and the two colors 8 and 10 introduced above. At this point, the concept of color math is introduced to students who need to discover how they can use the colored diary slips so as to represent the financial effect of each transaction onto the storyboard.

A more particular view of each of the horizontal slips 16 of the transaction diary 12 is shown in FIG. 2b. The white column 18 includes information about the transaction such as the date and particular details of the transaction. The first column 20 and second column 22 include information about a particular transaction, such as value, transaction number, etc. The first column 20 and the second column 22 are actually perforated tabs that can be removed from the transaction diary 12 to be placed in a transaction receptacle. The verbal indicia on each slip 16 allows the student to recognize that every transaction has an equal and opposite transaction. Therefore, an amount entered into the first column 20 causes an action in a particular column, source and/or use. As a result, an equal amount should be entered in the second column 22. The equal amount in the second column 22 represents an equal and opposite reaction in another section of the starting sheet.

To use the slips, a student enters an amount on a slip from column 20 and on a corresponding slip from column 22 and also records the transaction in column 18. The student then removes the slip from the transaction diary 12 and separates them. One of the slips identified with color 8 is placed in a basket somewhere on the starting sheet, for example in the use column 4. A corresponding slip must then be placed somewhere else on the starting sheet. If the first slip (identified with color 8) was placed in the use column, then the second slip (identified with color 10) should be placed in the source column 6 if the transaction calls for it. In reality, these slips represent borrowing of funds from the source column and availability of those funds in the use column. Students intuitively realize that, since the source column is represented by color 10, placing a similarly colored slip in a basket in the source column represents an increase in the source of funds available (liabilities, equity or (later) income); conversely, students also realize that placing a similarly colored slip in the use column represents an increase in available funds in the use column.

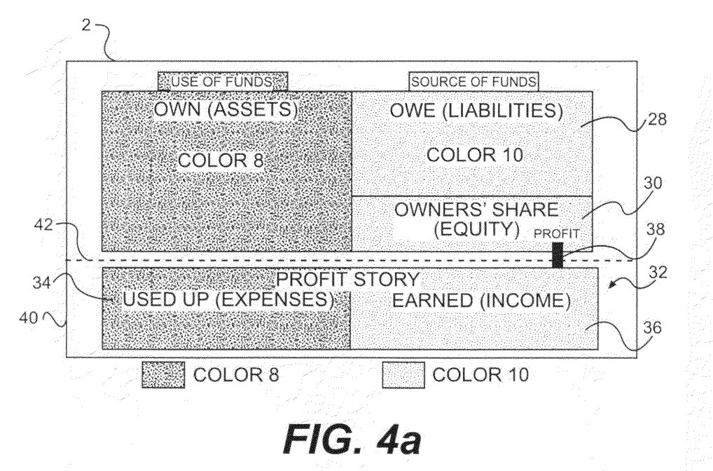

Transaction receptacles are shown in FIG. 3 as plastic cups (or baskets); however, these receptacles can be any container that can be placed on the starting sheet 2 and still allow a student to differentiate between sections of the starting sheet 2. These cups are essentially metaphors for accounts. The students decide that they need a basket 24 (shaded with color 10) to represent a loan from party X and a basket 26 (shaded with color 8) to represent cash at a bank that the business now has. The color metaphor continues and allows the students to determine that a Color 10 basket 24 belongs on the Color 10 side of the storyboard and conversely that a Color 8 basket belongs on the Color 8 side. Upon the occurrence of a transaction, horizontal slips 16 from the transaction diary 12 are placeable inside the baskets to provide a student with a visual understanding of the transaction. For example, upon receipt of a loan, a horizontal slip from column 22 of the transaction diary 12 is identified with an amount of the loan and placed in the basket 26 to represent the source of the funds (which will later be termed a debt). At the same time, a horizontal slip from the column 20 is placed in basket 24 to show funding has been used to increase the amount of cash held. The baskets are placed on their respective sides of the starting sheet 2.

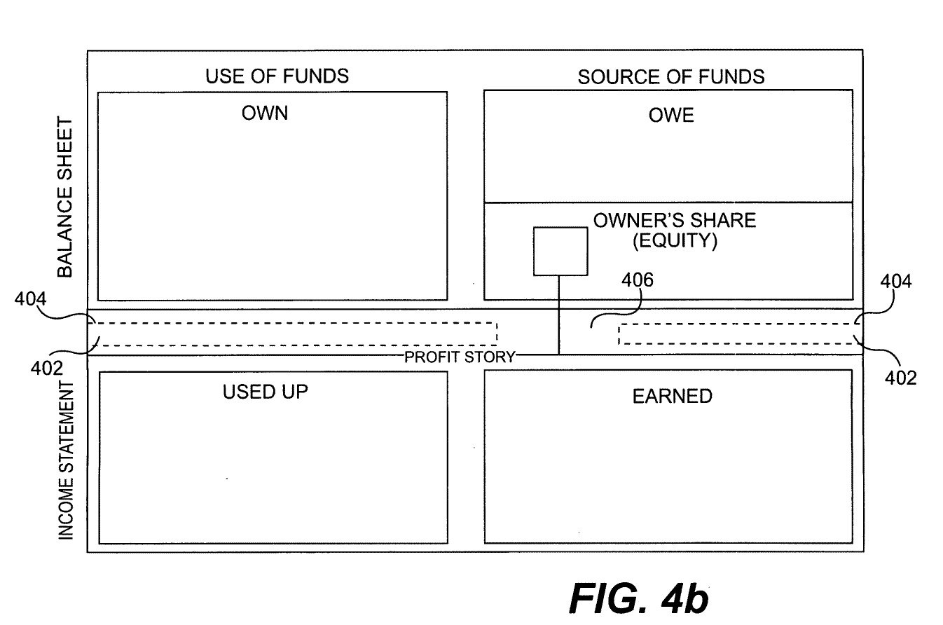

Until now, the starting sheet has included only the use column 4 and the source column 6. These columns can be represented on a single sheet or separate sheets. Preferably, both columns 4 and 6 are represented on a single sheet 2. As represented in FIG. 4, the source column side 6 of the starting sheet 2 is subdivided into two sections, liabilities 28 and equity 30. The equity section 30 includes a profit subsection 32. The profit subsection 32 is represented by two sub-sub-sections: an expense sub-sub-section 34 and an earned (income) sub-sub-section 36. When all of the sections are represented on a single page, the starting sheet 2 should take up half of a page and the profit sub-subcategory 32 (alternatively referred to hereinafter as “profit sheet”) should take up the other half of the page 40, which is separated from the starting sheet 2 by fold line 42. When a single page is used to display the entire funding story, connection 38 is used to show that the profit sub-subcategory 32 is a part of the equity subcategory 30 (which is a part of the source column 6). When using a hard copy of the starting sheet (as opposed to a computer program), the starting sheet is perforated (as shown in FIG. 4b) so that when the profit sheet is unfolded, a student can remove extraneous paper 402 along perforations 404, thereby leaving only a physical “bridge” 406 between the profit sheet and the equity section and thus showing that the profit sheet is connected to the equity subcategory on the source side of the sheet. As such, the profit sheet is simply an expanded sub-sub-category of the equity subcategory. In software applications, the profit story would be a type of “drill down” providing the specifics of the equity subcategory. For example, if the sections of the profit sheet were shown in Microsoft Windows®, a person would “click” on the profit subsection to expand the expense and income sub-sub-sections. Optionally, additional profit baskets are provided to represent expenses 34 and income 36 being the two elements that combine to calculate profit.

### Method

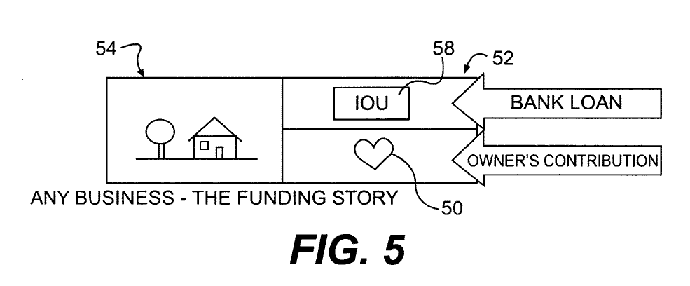

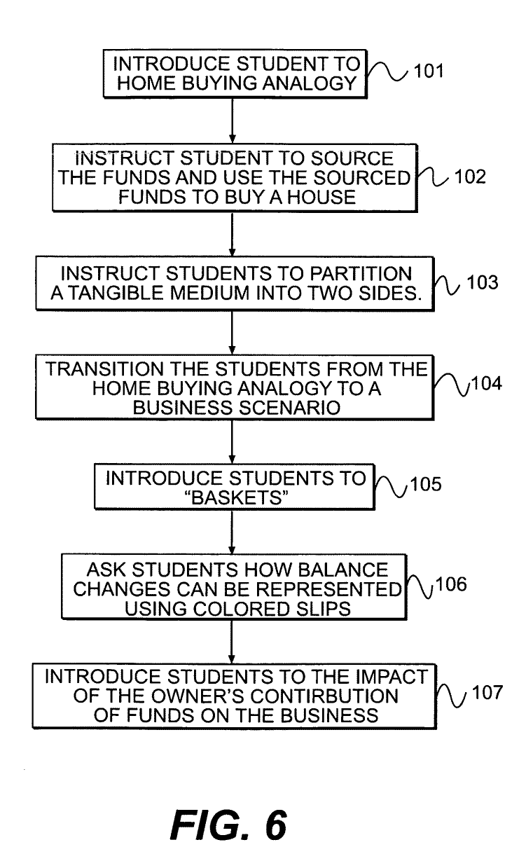

As mentioned above and as shown in FIG. 5, to teach students accounting, an example of the funding story of buying a house is used. As shown in FIG. 6, Step 101 is to introduce the student to the analogy of buying a home. Step 102 is to teach the student (the buyer in the house buying funding story) that she needs to source the funds and then use those funds to acquire the house. Two sides of the funding story relating to the house are developed: the SOURCE of the funds 52 (in FIG. 5), and then the USE of the funds 54 (in FIG. 5)—the same funds, two different perspectives. The “actual” source of the funds is not important for the purposes of teaching students; the funds can be sourced by personal friends 50, the home buyer, grants, bank loans 58, etc.

At step 103, students are taught to partition a tangible medium (such as the starting sheet 2 described above) into two sides, i.e., the two sides of the funding story, by using color 8 (green, for example) to indicate the use of the funds in the funding story, and color 10 (yellow, for example) to signify the source of the funds in the funding story. The starting sheet 2 is folded in half such that the bottom half of the starting sheet is not apparent to the student and only the asset, liability and equity areas are visible.

Students are then shown that a profit sub-section can be added on the source column side of the starting sheet 2 (specifically, the equity section of the source column) and then expanded into an expense sub-sub-section and an income sub-sub-section. If this system were being taught using a computer and screen, the profit section of the equity section in the source column would be displayed as a drill-down type of icon on which students can click to enlarge the profit sheet. The profit section's sub-sub-sections extend horizontally across the source and use columns such that the expense subsection 34 falls under the use of funds column 4 and is accorded the same color 8 as the rest of the use of funds column 4 and the income sub-sub-section 36 falls under the source of funds column 6 and is accorded the same color 10 as the rest of the source of funds column 6.

At step 104, students transition from buying a home to running a business. The student starts a business from scratch. As each business activity occurs, the students discover and develop their own accounting system to capture the financial impact of the transaction. The earlier color system and spatial locations from the house-funding story are continued and built upon. Similar to the home buying analogy, the first business transaction involves the business acquiring funds which it uses to acquire some productive assets. The students determine that as a result of this activity the business now has more cash, and also has more debt—a loan. The impact on the funding source and use are determined and the funding story remains in balance.

At step 105 the students are introduced to baskets. They determine that the baskets indicate the existence of the loan and the available cash, but do not as yet provide the story of the amounts involved. The students discover the need for a device that they can use to demonstrate the two affects on the storyboard of any transaction. A common misconception of a transaction in this system is that funds are moving from one place to another on the story board. Rather, the two simultaneous affects from each transaction are being described at once on the storyboard (in two places).

At step 106, the students are introduced to “color math.” Students are asked to determine how an increase in the balance of a green colored basket (for example) would be logically represented using the colored horizontal slips 16 from the transaction diary 12. On their own, the students determine that by adding a Color 10 slip to a Color 10 basket represents an increasing balance in that basket (Color 10 plus Color 10 equals more Color 10). Similarly, students determine that adding a Color 8 slip to a Color 8 basket represents an increase in the value represented by that Color 8 basket). This replaces the ‘technology’ espoused in the previous art, which attempts to start from this point by providing the user with one or more ‘rules’ which the user must accept and learn by rote. Later students learn that adding a color 8 slip to a color 10 bucket reduces the value in the color 10 bucket, and vice versa.

At step 107, students are introduced to the owner's contribution of funds to the business—the source of funds is the owner's contribution and the use of funds is to fill up the bank account with cash. This source of funds is differentiated from the loan funds and so the students decide to create a new section on the source of funds side of the storyboard—owner's share (equity) which was also pre-learned during the ‘buying a house’ activity. In accounting terminology, students are differentiating between liabilities and equity and deciding that they need a separate section for each on the Color 10 side (Source of Funds).

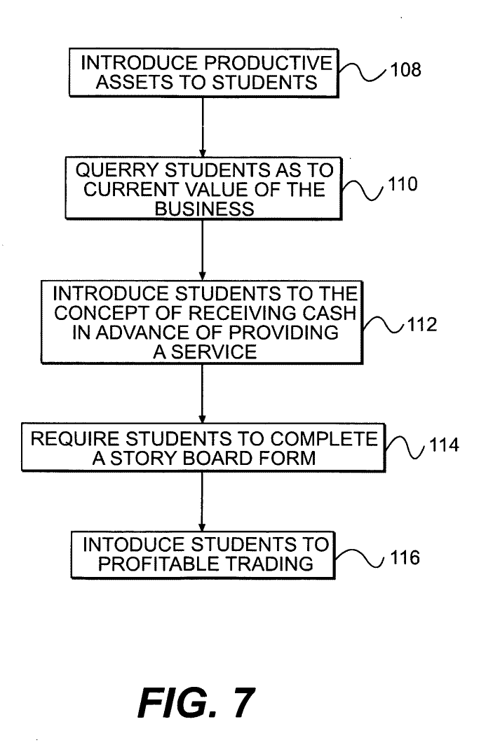

As shown in FIG. 7, step 108 involves introducing productive assets to students. Productive assets are assets that earn more source funds for the company. Some of the productive assets are paid for and some are on credit, which further embed the existing lessons in the students. After the acquisition of productive assets (and other subsequent transactions), at step 110 the students are asked how much their business is worth in an accounting sense (accounting net worth). This is to bring the concept of accounting net worth to their attention so when the business begins trading, the students can readily determine the impact of business transactions on the accounting net worth of the underlying business.

At step 112, the students are introduced to the concept of receiving cash in advance of delivering a service. It invokes learning about when income can be recognized and when it cannot (accrual accounting). The students determine for themselves, that even though the business has the cash, it still owes the customer for the promised service. This is the start of them discovering that cash accounting and accrual accounting are different. Later it becomes part of their learning that profit is not necessarily represented by cash. To represent this lesson using color, an asset (other than cash) is generated/increased by a green color 8 slip in a green bucket, and a color 10 slip increases a yellow income bucket. Or a color 10 liability bucket is reduced by a color 8 slip, at the same time as a color 10 slip increases a color ten income bucket.

Students determine that the profit basket can be expanded by using ‘profit sub-baskets’ to represent income and expenses, which combine to calculate profit. The students now unfold their starting sheet to reveal an additional area that they can use to tell the profit story. The Color 8 and Color 10 sides continue downwards into the new area as does the vertical dividing line. A third color is used to draw a ring around the circumference of the new section known as the profit story (income statement) and shows visually that it connects to the profit basket on the balance sheet. A vertical line is used to surround and connect the expanded profit story with the profit basket in the owner's share section.

Using the established color code for source and use of funding, the students determine where the income and expense baskets should be located in the profit story: income is a source of funds and therefore the income baskets should reside on the Color 10 side and vice versa for expenses. In fact, expenses are USED UP funds providing no further benefit to the business and are therefore not an asset. Consequently, these funds form part of the profit story of the business.

In step 114, the students then complete a pre-printed form laid out in the same way as the starting sheet 2 with the additional equity section 32 but only using the names of the baskets and the totals. They total up each of the three sections as well as the two sides to prove that the funding story is in balance. This form is actually a balance sheet. From the form, they can see that the assets of their business have been funded from two sources: liabilities (debt) and equity. Immediately, they can see the concept known as gearing (leverage), which many accounting students typically find so challenging. And with the addition of operating income, they see that revenue or income is the third source of funds.

In the last step, step 116, students are introduced to profitable trading as a source of finds available to a business. Students are now able to determine where the profit basket should be placed on the storyboard: it represents a source of finds and is to the benefit of the owners so it should be located in the owner's share (equity) section of the storyboard.

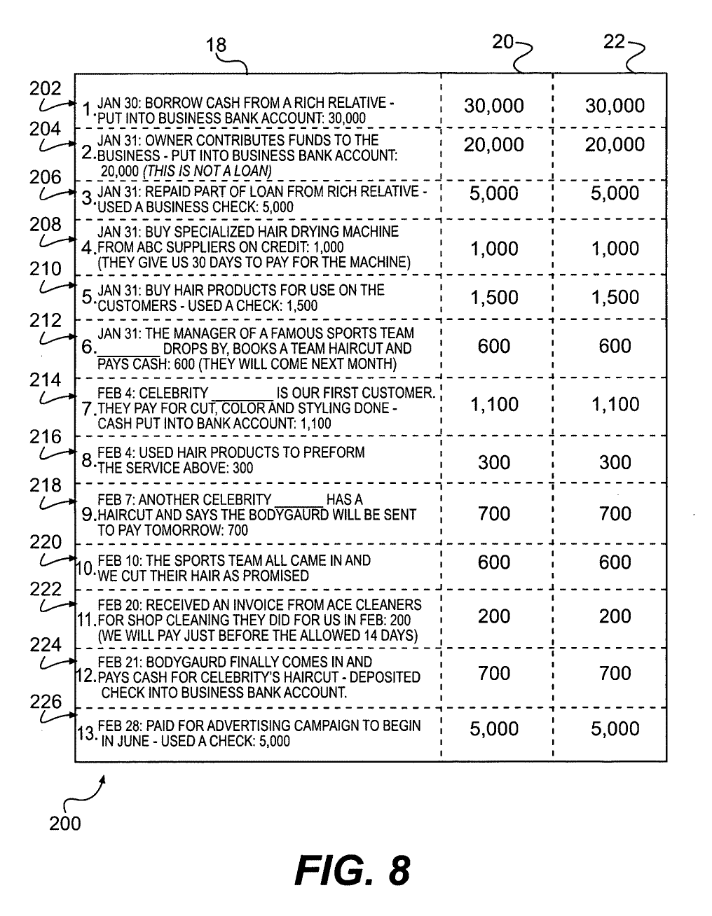

Students' learning is enhanced by the order in which they are introduced to different types of transactions. With respect to FIG. 8, a reproduction 200 of a page of diary 12 is shown. As shown in FIG. 2a, reproduction page 200 includes a white column 18 for documenting the details of each transaction, a first column 20 having the first color 8 and second column 22 having the second color 10. Values for each transaction are printed in columns 20 and 22. There are various separate transactions identified in column 18 of the reproduction 200. The order (from top to bottom) in which these transactions are introduced to a student helps a student build a proper understanding of accounting. For example, the first two transactions 202 and 204 introduce increasing transactions to a student, which means that the color associated with each transaction causes an increase in a bucket on the starting sheet 2 having the same color. Thus, the tab of transaction 202 from column 20 would be removed and placed in a bucket on the use side of the starting sheet 2 since both the use side and the tab from column 20 are associated with color 8. Likewise, the tab of transaction 202 from column 22 would be removed and placed in a bucket on the source side of the starting sheet 2 since both the source side and the tab from column 22 are associated with color 10.

The next type of transaction that is introduced to the student is a type that results in a decrease in the value of an account on the starting sheet 2. In transaction 206, the use of funds column will be reduced by $5,000 because those funds have been used up to repay a loan. Similarly, the source of funds column will be reduced by $5,000 because the amount owed to a creditor is reduced by the same amount. Students quickly learn that introducing an opposite color into the bucket reduces the value of the bucket. Transaction 208 introduces the concept of accounts payable.

Transaction 210 is a transaction teaching the possibility of an activity happening in only one section of the starting sheet, in this case, the assets section. Transaction 210 introduces an increase in owned assets, e.g., recently purchased hair care products, and a reduction of the cash account used to pay for the hair care products. Transaction 212 is a transaction teaching accrual accounting, i.e., the business received payment for a service that it has yet to perform.

Transactions 214 and 216 are transaction to teach when income is earned and its associated affects. In transaction, 214, a service is performed and the business immediately receives payment. The value of a basket in the income sub-sub-section is increased by the amount charged for the haircut ($1,100) and the value of a basket in the assets section is increased to represent the addition of cash in the business's bank account. Similarly, transaction 216 represents a decrease in assets (the use of the hair care products) and an increase in expenses (showing that the hair care products have exhausted their value to the business).

Transaction 218 represents an introduction to accounts receivable. In this transaction, a service is performed, thereby representing an increase in accounts receivable (an asset) and an increase in income; however, payment has not yet been received. It is notable that income can be increased without having received payment. This is because receipt of payment is represented in the “use” column as an asset. Performance of the service is what signifies an increase in income; payment for the service is associated with an income in assets. Transaction 224 represents payment for the haircut thereby increasing the value of the assets section and decreasing the accounts receivable, which is also within the assets section.

Transaction 220 is related to transaction 212. In transaction 212, payment for the yet to be performed service is represented by an increase in assets as well as by an increase in liabilities. However, in transaction 220, performance of the service represents an increase in income and a decrease in liabilities.

Transaction 222 is a transaction teaching an increase in expenses (receipt of Ace Cleaners' shop cleaning) and an increase in liabilities (payment owed but not yet paid to Ace Cleaners). Transaction 226 is a transaction teaching payment for a yet to be delivered expense. In transaction 226 assets are reduced (in the form of $5,000 cash) for payment for a future advertising campaign and the value of the assets section (in the form of a prepaid-expense asset) is increased because a third party is in debt to the business.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

I claim:

1. A method of teaching accounting comprising the steps of:
providing a starting sheet having a use column and a source column wherein said use column and said source column are influenced by a plurality of actions and by a plurality of reactions,
representing a first action by a first non-verbal symbol and representing a first reaction by a second non-verbal symbol; and
representing said use column by said first non-verbal symbol and representing said source column by said second non-verbal symbol.

2. The method as recited in claim 1, wherein said first non-verbal symbol is selected from the group consisting of color, sound, texture, and fragrance.

3. The method as recited in claim 2, wherein said second non-verbal symbol is selected from the group consisting of color, sound, texture, and fragrance.

4. The method as recited in claim 3, further comprising using at least one ancillary container to represent an amount within said use column or within said source column.

5. The method as recited in claim 4 wherein said at least one ancillary container is comprised of one of said first non-verbal symbol or said second non-verbal symbol.

6. The method as recited in claim 5, further comprising a second ancillary container.

7. The method as recited in claim 4 wherein said second ancillary container is comprised of one of said first non-verbal symbol or said second non-verbal symbol.

8. The method as recited in claim 1 wherein a magnitude of said first action is equal and opposite to said first reaction.

9. The method as recited in claim 8 further comprising adding a profit story sheet to said starting sheet wherein said profit story sheet is comprised of a used-up funds column and an earned funds column; and
positioning said used-up funds column in vertical alignment with said use column and positioning said earned funds column in vertical alignment with said source column.

10. A system of teaching accounting comprising
a starting sheet having a use column and a source column,
a first non-verbal symbol and a second non-verbal symbol, wherein said first non-verbal symbol represents a first transaction, and wherein said second non-verbal symbol represents a second transaction; and
a profit story sheet comprising a used-up funds column in vertical alignment with said use column and an earned funds column in vertical alignment with said source column.

11. A system of teaching accounting as recited in claim 10 further comprising a first container representing a financial account within one of said use column, said source column, said used-up funds column or said earned funds column.

12. The system as recited in claim 11, wherein said container is comprised of said first non-verbal symbol.

13. The system as recited in claim 11, wherein said first non-verbal symbol is selected from the group consisting of color, sound, texture, and fragrance.

14. The system as recited in claim 10, further comprising a second container representing a second financial account.

15. The system as recited in claim 14, wherein said second container is comprised of said second non-verbal symbol.

16. The system as recited in claim 15 wherein said second non-verbal symbol is selected from the group consisting of color, sound, texture, and fragrance.

17. The system as recited in claim 10, further comprising a container representing an account associated with said profit sheet.

18. The system as recited in claim 17 wherein said container is comprised of said first non-verbal symbol or said second non-verbal symbol.

19. The system as recited in claim 18, wherein said first or said second non-verbal symbol is selected from the group consisting of color, sound, texture, and fragrance.

20. The system as recited in claim 1 wherein said first transaction is equal and opposite to said second transaction.
